(19) United States
(12) Patent Application Publication
(10) Pub. No.: US 2024/0189976 A1
(43) Pub. Date: Jun. 13, 2024

(54) FURNISHING PLANNING SYSTEM, CONTAINER, STENCIL, AND METHOD FOR USING A FURNISHING PLANNING SYSTEM

(71) Applicant: Barbara Choi KRONSCHEWSKI, Frechen (DE)

(72) Inventor: Barbara Choi KRONSCHEWSKI, Frechen (DE)

(21) Appl. No.: 18/556,341

(22) PCT Filed: Feb. 15, 2022
(86) PCT No.: PCT/EP2022/053630

§ 371 Date: Oct. 19, 2023

(30) Foreign Application Priority Data
Apr. 20, 2021 (DE) 10 2021 109 984.6
May 21, 2021 (EP) 21175223.3

(51) Int. Cl. B25H 7/02

(52) U.S. Cl. CPC B25H 7/02

(57) ABSTRACT

A furnishing planning system in particular for assisting with the selection of the number, arrangement and/or configuration of pieces of furniture and/or the ordering of same, includes at least one simulation device configured for simulating the space requirement of a piece of furniture in a real space to be furnished.

### CROSS-REFERENCE TO RELATED APPLICATIONS

This application is a 35 U.S.C. § 371 National Stage patent application of PCT/EP2022/053630, filed on 15 Feb. 2022, which claims the benefit of German patent application 10 2021 109 984.6, filed on 20 Apr. 2021, and which claims the benefit of European patent application 21175223.3, filed on 21 May 2021, the disclosures of which are incorporated herein by reference in their entirety.

### TECHNICAL FIELD

The present disclosure relates to a furnishing planning system according to the preamble of claim 1, a container according to the preamble of claim 11, a stencil for furniture construction according to the preamble of claim 12 and a method according to the preamble of claim 14. Within the context of this description, the furnishing planning system is also referred to as the system for short.

The system is intended in particular to assist a customer, for example of a furniture supplier, with planning the furnishing of a room to be furnished with pieces of furniture.

In particular, the disclosure is used for the planning and design of furniture, kitchen furniture, electrical household appliances, shelves, cabinets, etc. (hereinafter uniformly referred to as pieces of furniture).

### BACKGROUND

According to convention, to assist a customer with planning the furnishing of a room to be furnished or to configure kitchens but also other pieces of furniture such as shelves, cabinets, etc., special tools are used in which the future piece of furniture can be planned or configured in multiple steps. Typically, the planning or configuration is carried out by means of 3D-based software, with which a piece of furniture can be individually planned or configured by means of various selection options. In principle, the planning or configuration of the furniture types according to different selection criteria is also very individual and the finished concept can later be examined in a realistic 3D view.

However, the disadvantage here is that for configuring such a piece of furniture, the room dimensions must be recorded very precisely, which is often difficult for the customer or layman to do with the necessary accuracy, also because possible obstacles (projections in the brickwork, etc.) are not taken into account. Furthermore, the customer is usually unable to get an accurate picture of the exact dimensions of the planned or configured piece of furniture if it is only shown in a 3D model on the screen.

### SUMMARY

The present disclosure creates a furnishing planning system, a container, a stencil and a method for using a furnishing planning system, which are improved with respect to at least one of the mentioned disadvantages.

This is achieved by providing a furnishing planning system with the features of claim 1, a container with the features of claim 11, a stencil with the features of claim 12 and a method with the features of claim 14.

The features set forth individually in the claims can be combined in any technically useful manner to disclose further embodiments of the disclosure. For example, the features set forth in connection with the stencil can generally also be combined with the simulation device and vice versa. The description further characterizes and specifies the disclosure, particularly in connection with the figures.

The furnishing planning system according to the disclosure serves in particular to assist a customer with selecting the number, arrangement and/or configuration of pieces of furniture and/or the ordering thereof.

The furnishing planning system according to the disclosure includes at least one simulation device for simulating the floor space requirement—preferably in real size—of at least one piece of furniture in a real room to be furnished.

This creates a prerequisite for a customer to be able to independently, i.e. in particular without a professional consultant or salesperson, select and/or order the number and/or configuration of one or more pieces of furniture suitable for the room to be furnished. In addition, a prerequisite is created for furnishing planning to be possible without measuring the room to be furnished, whereby measuring errors are avoided. Further sources of error, such as overlooking a non-rectangularity of the room to be furnished or overlooking a protrusion, can also be eliminated at an early stage. Preferably, the customer can arrange or set up or lay out the at least one simulation device in his room to be furnished and directly convince himself or herself of the correct size or select another simulation device or resize of the simulation device.

With the aid of the simulation device according to the disclosure, it is preferably possible to recognize and imagine the room conditions, preferably also lighting conditions.

Preferably, the simulation device allows furniture sizes and ratios in the real room to be represented or simulated. Preferably, the simulation device thereby enables an immediate check of the size (depth, width, height) of the furniture in the real room intended to be furnished or in another real room. Advantageously, in this manner, the lighting conditions and/or distances or walking paths to various existing real objects such as protrusions, unevenness, and/or irregularities of a real room can be experienced.

Multiple simulation devices, preferably in all common sizes of the furniture industry, can advantageously be brought together in a form-fitting manner with the help of connections, so that, for example, a complete fitted kitchen can be set up in a two- or three-dimensional structure in paper, cardboard, or by means of other materials.

Each simulation device preferably comprises special scannable and/or electronically readable information from which, more preferably, the data on the width, depth and/or further information on the simulation device used can be read.

For example, after multiple simulation devices have been combined to form an entire piece of furniture (e.g., a kitchen, a shelving system, etc.), the information on the simulation devices can preferably be read in, in particular with the aid of software (e.g., a smartphone app) and, more preferably, the corresponding piece of furniture can be configured, e.g., by means of the software.

In the context of the present printed matter, the term “configuration” refers in particular to the selection of the size and/or the kind or type and/or the decor of a piece of furniture. In this regard, the size preferably comprises the shape and size of the floor plan of the piece of furniture and can also comprise the height of the piece of furniture. The kind or type comprises, for example, the absence or presence or number or design of compartments, drawers, shelves and/or electrical appliances. The decor preferably comprises the design of surfaces, textures, colors, of any countertops, of any front, and/or of any handle.

A real room to be furnished is to be understood to mean the real, i.e. not simulated or replicated, room to be furnished.

Since the simulation can take place in a real room to be furnished, and the room to be furnished does not have to be reproduced, possible errors and the expenditure of a possible reproduction of the room to be furnished are avoided. This can be particularly advantageous, among other things, for rooms to be furnished that are full of nooks and crannies and cannot be replicated or can only be replicated with a great deal of effort.

In the context of this description, a piece of furniture means in particular a commercially available or common piece of furniture. Preferably, the piece of furniture has a standard width and a standard depth.

The term “floor space requirement” is to be understood to mean the footprint requirement and/or the space requirement.

Preferably, the simulation device comprises at least one simulation object and, in particular, does not act merely virtually.

Advantageously, the simulation device comprises or is formed by at least one physical placeholder or a physical replica of a piece of furniture or the floor plan of a piece of furniture. Compared to a conceivable virtual or optical simulation device which, for example, merely displays the floor space, the simulation can thus be particularly simple and also particularly meaningful.

The usability of the furniture planning system can be facilitated if the mass of the simulation device is less than half or one third or one quarter or one tenth of the mass of the piece of furniture it simulates.

In a particularly advantageous embodiment, the width of the simulation device corresponds to a standard width of a piece of furniture and/or the depth of the simulation device corresponds to a standard depth of a piece of furniture.

The height of the simulation device can correspond to a standard height of a piece of furniture. Preferably, the height of the simulation device can preferably also be referred to as the thickness of the simulation device.

Preferably, the height of the simulation device is many times smaller than the standard height of a piece of furniture. In particular, in this embodiment, the simulation device can be provided for laying out on the floor of the real room. Advantageously, the height of the simulation device is selected independently of the standard height of a piece of furniture, for example according to a minimum height required for the stability of the simulation device. It has been shown that a meaningful simulation is already achievable if the piece of furniture is only simulated with respect to its width and/or depth.

In particular, in the embodiment in which the height and width of the simulation device correspond to a standard height and standard width of a piece of furniture, the depth of the simulation device can be many times smaller than the standard depth of a piece of furniture. In particular, in this embodiment, the simulation device can be provided for placement against a wall of the real room and can simulate, for example, a shelf.

If the simulation device is plate-shaped or planar or two-dimensional, then the customer can easily come into possession of the at least one simulation device, for example by mail order.

In particular, in this embodiment, the furnishing planning system can comprise a height indicating device, for example for indicating and facilitating the selection of different heights of the at least one piece of furniture, thus, for example, the working height of a kitchen.

The simulation device can comprise or be formed from cardboard, paper, plastic, wood, metal or other material.

Advantageously, the outline of the—preferably plate-shaped—simulation device has exactly the shape and size of the floor plan of the piece of furniture simulated by the simulation device. Preferably, the outline of the—preferably plate-shaped—simulation device is quadrangular or rectangular, having a width and a depth. The outline can also be square. If the simulation device reproduces the floor plan of a piece of furniture on a scale of 1:1, or if its outline corresponds at least substantially to the floor plan of a piece of furniture, then a precondition is again created for particularly easy and direct applicability of the system, which preferably does not require any measuring. The term “outline of the simulation device” refers in particular to the outline without taking into account any connecting means.

In its intended state of use, the simulation device can also be three-dimensional or voluminous, for example cuboidal, instead of plate-shaped and, more preferably, can be folded into a plate shape before or after the intended use. The foldability can be carried out in a scissor-like manner or in the manner of a folding box. In this embodiment, the non-foldable simulation device can have at least approximately the volume and shape of the piece of furniture it simulates. Preferably, then, the volume of the simulation device in its folded state is less than half or a third or a quarter or a tenth of the volume of the piece of furniture that it simulates.

The simulation device can have a sign indicating which way round it is to be arranged. For example, a front edge of the simulation device which has to face away from the wall of the room to be furnished can be indicated.

Preferably, the simulation device has at least one piece of information that can include the configuration or an aspect of the configuration of the exact piece of furniture simulated by the simulation device, for example the type and/or width. This creates a prerequisite for the customer to be able to uniquely identify his configuration independently, i.e. in particular without a professional advisor or salesperson, in a simple manner and preferably without measuring.

The information is preferably scannable and/or electronically readable. The simulation device can comprise the information in machine-readable form, thus, in particular in a form optimized for electronic scanning, e. g., in the form of an information code. For example, the simulation device can comprise the information in the form of at least one barcode or QR code.

Advantageously, the customer can create a first configuration, for example, regarding a size of at least one piece of furniture, e. g. by selecting a simulation device and/or by resizing it. Preferably, this configuration can be simulated and verified in the room to be furnished by means of the at least one simulation device. Preferably, depending on the result of this verification, the configuration can be maintained, the information of this at least one simulation device can be read in or entered, or the configuration can be discarded. Preferably, a new configuration can then be created, which, more preferably, is verifiable again using a different simulation device.

A single simulation device can simulate different pieces of furniture, for example different types of pieces of furniture, e.g. with the same floor plan and/or differently equipped pieces of furniture and can include a separate piece of information for each simulated piece of furniture.

A single simulation device can simulate a size or type of furniture defined, for example, by the same carcass in different decors, for example, the size and type defined by a base cabinet of a certain size that can be equipped, for example, with a variable number of drawers and/or compartments and/or different doors.

The simulation device can comprise different pieces of information which contain different configurations and are separate from each other. The pieces of information can each be associated with an illustration or symbol of the simulation device that identifies the particular configuration of the simulated piece of furniture for a customer.

If the simulation device comprises aids for resizing by the customer, in particular aids for resizing its outline, the number of required simulation devices can be reduced while the simulation device remains easy to use. The resizing aids can enable or assist with resizing the simulation device, for example by cutting it to size, preferably using paper scissors, or by folding it, or by tearing it off preferably in such a manner that a single simulation device can reproduce different floor plans of different pieces of furniture. Preferably, the width and/or depth of the outline of the simulation device can be changed. The resizing aids can include markings. The markings can define cutting edges or folding edges or tear-off edges of the simulation device. Markings can also include, for example, printed, glued, punched, painted, sprayed, etched, engraved, embossed visual highlights or highlights applied, attached or inserted in any other conceivable manner, for example in the form of lines, dots, elevations, indentations, recesses. Likewise, punch-outs, perforations, predetermined breaking points or holes can be formed as markings. The resizing aids can comprise depth markings and/or width markings. Advantageously, the resizing aids are configured such that, after the resizing, a section of the simulation device remains whose shape and size can correspond to the outline of the piece of furniture, in particular standard piece of furniture, that it simulates. Preferably, the shape and size of each section corresponds to the floor plan of a piece of furniture. If the resizing aids are provided to assist with the resizing in predetermined stages, then the use of the system is further facilitated for the customer. Preferably, the stages each correspond to standard dimensions of pieces of furniture. In addition, the usability of an information of the simulation device containing the size can then be maintained, in particular if the simulation device includes multiple pieces of information each associated with a section.

In a particularly advantageous embodiment, the width of the simulation device corresponds to a standard width of a piece of furniture and/or the depth of the simulation device corresponds to a standard depth of a piece of furniture. Preferably, the simulation device can be resized using the resizing aids such that the width of the simulation device corresponds to a standard width of a piece of furniture and/or the depth of the simulation device corresponds to a standard depth of a piece of furniture.

For example, the standard width of a piece of furniture can be about 10 cm, 15 cm, 20 cm, 25 cm, 30 cm, 40 cm, 45 cm, 50 cm, 60 cm, 80 cm, 90 cm, 100 cm, or 120 cm. For example, the standard depth of a piece of furniture can be about 35 cm, 46 cm, 55 cm, or 58 cm.

Preferably, the simulation device can be brought to a selectable standard width and/or standard depth for pieces of furniture by means of the resizing aids, preferably by shortening.

The simulation device can include various pieces of information uniquely associated with its various sizes or sections. For example, the pieces of information can each be located at the edge of the simulation device or at a marking, and can each comprise the size associated with the associated edge or marking or section defined by that marking. In other words, a separate piece of information can be provided for each possible depth and/or width of the simulation device.

In one embodiment variant, the furnishing planning system also comprises, for example, scannable and/or electronically readable information that is not arranged on the at least one simulation device. The system can comprise a digital or printed brochure illustrations and/or sample compartments and/or software that can include this information, preferably similar to the information of the simulation device.

The at least one simulation device can comprise a stencil or be formed by a stencil.

In a particularly advantageous embodiment variant, the system comprises multiple simulation devices which preferably differ from each other. More preferably, the system comprises connecting means for reversibly connecting multiple simulation devices to each other. The connecting means can comprise recesses of the simulation devices and connecting pieces complementary thereto. The connecting pieces can each be fixedly connected to a simulation device or can be configured separately from the simulation devices. The connecting pieces can be designed as connecting tabs. The system can comprise a simulation device in the form of a corner piece. The outline of the corner piece can be non-rectangular.

Preferably, the multiple simulation devices differ in width, in one embodiment exclusively.

In the embodiment comprising multiple simulation devices, each of the multiple simulation devices preferably comprises at least one piece of scannable and/or electronically readable information.

Advantageously, multiple simulation devices can be connected by means of the connecting means to form a unit with a defined overall outline, for example to form a simulated fitted kitchen. This makes it possible to check in a particularly simple and precise manner whether the overall outline, formed by multiple pieces of furniture, fits into the room to be furnished.

Even in the case of multiple connected simulation devices, the outline of the simulation device preferably has exactly the shape and size of the floor plan of the piece of furniture simulated by it.

Preferably, the furnishing planning system comprises a set formed by multiple simulation devices. The set can be defined by the type of room to be furnished. For example, the set can be a kitchen set, a children's room set, a living room set, or a bathroom set. The set can comprise simulation devices matching a pre-selection of pieces of furniture. The pre-selection can relate to typical pieces of furniture. The pre-selection can relate to typical combinations of pieces of furniture. The pre-selection can relate to pieces of furniture of exactly one or more suppliers of pieces of furniture.

In a particularly advantageous embodiment variant, the furnishing planning system comprises software for an electronic data processing device or an electronic data processing device comprising software.

Advantageously, the data processing device comprises an electronic reading device. The data processing device can also comprise an electronic input device.

Preferably, the information, the reading device and the software are coordinated with each other or set up in such a manner that the information can be read in by means of the reading device and processed in the data processing device. The information can be at least partially input by means of the input device.

The electronic input device can be a camera. The electronic input device can be a touch screen and/or a keyboard. The electronic data processing device is preferably mobile and can be a smartphone or a tablet or a PC, for example a laptop. The software can be an app. Preferably, the software comprises a reading menu or a reading dialog. Preferably, the software is configured to query the reading or input of information containing a configuration of the customer by means of a selection or reading menu or dialog. This can facilitate the ordering process of the pieces of furniture.

The data processing device can comprise a database. In the database, prices of exactly one furniture manufacturer or multiple furniture manufacturers can be stored for different selections or configurations of the customer which are possible by means of the at least one simulation means.

Preferably, the software is configured to process entered and/or read-in data or information containing the customer's selection or configuration, for example to compare it with the database. The software can be configured to display the availability to the customer, the expected delivery time and/or the price of his selection or configuration, for example with regard to exactly one furniture manufacturer or multiple furniture manufacturers.

Processing can comprise creating or providing a universal template for quotes from various furniture manufacturers.

The software can be configured to display images reflecting the customer's selection or configuration easy verification of the reading and/or input process.

The software can further be configured to allow, for example after reading in information about the customer's configuration created using the simulation device regarding the size and/or type of the at least one piece of furniture, to input a selection made by the customer, such as regarding the decor of the piece of furniture.

The processing can also comprise, after a corresponding input of the customer, to trigger at a manufacturer of the piece of furniture an order process of at least one piece of furniture corresponding to the selection or configuration of the customer made by means of the at least one simulation device. Preferably, the system enables an order of at least one piece of furniture according to the selection or configuration of the customer without any intermediary or, for example, a kitchen studio.

The electronic data processing device can have an interface, comprising e.g. an internet connection, to a further electronic data processing device, for example to a server, e.g. of a furniture provider, and the data processing can be performed at least partially on this further data processing device.

Preferably, the system comprises a container for accommodating the simulation devices or set. Advantageously, the mass of the container together with the simulation devices is less than 25 or 10 or 5 kg. In this manner, the system can be easily transported by the customer or shipped by mail. The container can comprise cardboard and can be, for example, a cardboard box. The container can alternatively or additionally comprise paper, plastics, wood, metal or other material. The container can be a package or packet. The container can comprise the height indicating device, for example having markings at different heights.

The container for a furnishing planning system according to the disclosure includes multiple simulation devices for simulating the floor space of a piece of furniture in a real room to be furnished. The simulation devices differ from each other and form a set.

The present disclosure is further based on the eliminating the above-mentioned disadvantages and creating a stencil which is suitable for carrying out furniture planning which is simple and straightforward even for the layman.

According to the disclosure, the above is achieved according to the preamble of claim 11 in conjunction with the characterizing features. Advantageous embodiments and further developments of the stencil according to the disclosure are indicated in the dependent subclaims.

According to the disclosure, a stencil of the type mentioned at the beginning is characterized in that sections of different depth and/or width are marked by means of markings on a material at a defined distance of their outer edges to be produced from a side edge of the material, wherein at least one scannable and/or electronically readable information is associated with the stencil.

The scannable and/or electronically readable information is preferably applied in machine-readable form, i.e. in particular in a form optimized for electronic reading, for example as a barcode or QR code.

Preferably, at least one piece of scannable and/or electronically readable information is associated with each section of the stencil.

Preferably, at least one connecting means is provided on at least one side edge of the material, by means of which the material can be reversibly connected to the material of at least one further stencil.

Preferably, the connecting means is designed as a punched receptacle for inserting a connecting tab or as a connecting tab, wherein the receptacle of a material can be reversibly connected to the connecting tab or to the connecting tab of another material in that the connecting tab can be inserted into the receptacle in a precisely fitting manner.

Preferably, the connecting tab is designed to be inserted on each of its opposite sides into a receptacle of multiple materials.

Preferably, the receptacle for inserting the connecting tab on another material is designed in an appropriately corresponding manner.

Preferably, the connecting means is a magnetic connecting means as part of a magnetic connection, wherein the connecting means is a magnet or a magnetically attractable material appropriately corresponding to a connecting means formed as a magnet. The connecting means can comprise a hook-and-loop fastener, a detachable adhesive, and/or another connecting means.

Preferably, at least one connecting means is associated with each section.

Preferably, the defined distances correspond to the standard widths, depths and/or heights of kitchen furniture.

Suitable materials include flat materials such as cardboard, paper, flat plastics, etc. as well as three-dimensional structures.

Markings can be, for example, visual highlights that are printed, glued, punched, painted, sprayed, etched, engraved, embossed or otherwise applied onto or inserted into the material, for example in the form of lines, dots, elevations, indentations or recesses. Likewise, for example, punch-outs, perforations, predetermined breaking points or holes can be formed as markings, by means of which the user produces corresponding sections on the materials.

With the aid of the stencil according to the disclosure, it is preferably possible to identify and visualize the spatial relationships. Multiple stencils, preferably in all sizes commonly used in the furniture industry, can advantageously be brought together in a form-fitting manner with the aid of connections, so that, for example, a complete fitted kitchen can be set up in a two- or three-dimensional structure in paper, cardboard, or by means of other materials.

Each individual section on the material preferably comprises special scannable and/or electronically readable information, from which, more preferably, the data on the width, depth and/or further information on the stencil used can be read.

For example, after multiple stencils have been combined to form an entire piece of furniture (e.g. a kitchen, a shelving system, etc.), the information on the materials or the created sections can preferably be read in, in particular with the aid of software (e.g. a smartphone app), and the corresponding piece of furniture can preferably be further configured, e.g. by means of the software.

For this purpose, the user can be provided with various selection criteria for configuration, as known, for example, from the aforementioned prior art. Here, the selection of furniture types, surfaces, structures, drawers, shelves, colors, handles, worktops, electrical appliances, etc. pp. come into consideration, to name just a few examples. These pieces of information can be (at least) partially content of the information illustrated on a stencil.

Preferably, the software makes it possible to bundle all the information that has been read in or scanned and preferably place it in the shopping cart. Thus, it is also possible that each section of the stencil is associated with at least one piece of scannable and/or electronically readable information from which preferably the width, depth, height and/or further information can be read, so that the user preferably does not have to manually enter this information into the software or a data processing device.

The pieces of information on the stencil and/or on the sections are preferably read in in a defined sequence of the stencils aligned by the user from left to right or vice versa.

The user can also be provided with further information and/or instructions, for example written information and/or instructions, by means of which a simple and individual configuration of the piece of furniture is carried out or can be carried out. For example, a kitchen furniture manufacturer can supply a digital or printed brochure together with the stencils, in which detailed information on individual specifications and/or configuration options of the piece of furniture are listed.

The method according to the disclosure for using a furniture planning system comprises the following steps:
configuring at least one piece of furniture by selecting and/or resizing a simulation device,
simulating the configuration in a real room to be furnished by means of the at least one simulation device, preferably by means of laying out the at least one simulation device on the floor of the real room to be furnished,
checking the configuration,
depending on the result of this check, either keeping the configuration, or
   discarding the configuration and creating new configuration and re-simulating and checking the new configuration.

Preferably, after keeping the configuration, the information of the at least one selected and/or resized simulation device is input and/or read into the electronic data processing device.

The simulation of the configuration in a real room to be furnished by means of the at least one simulation device can also be performed by placing the at least one simulation device against a wall of the real room to be furnished.

### BRIEF DESCRIPTION OF THE DRAWINGS

The present disclosure is explained in more detail below by means of exemplary embodiments with reference to the attached figures. These exemplary embodiments serve to facilitate the execution of the disclosure for the person skilled in the art. They do not limit the subject matter of the disclosure.

In the figures:

FIG. 1 shows a perspective illustration of an exemplary embodiment of an equipment planning system according to the disclosure with simulation devices still arranged in the container and designed as stencils;

FIG. 2 shows a top view of the simulation devices of FIG. 1, laid out in a real room to be furnished and connected to each other, in this case in an L-shape;

FIG. 3 shows a top view of a stencil according to the disclosure in an advantageous embodiment; and

FIG. 4 shows multiple stencils according to the disclosure forming a kitchen, in an advantageous embodiment as in FIG. 3 in plan view.

### DETAILED DESCRIPTION OF THE DRAWINGS

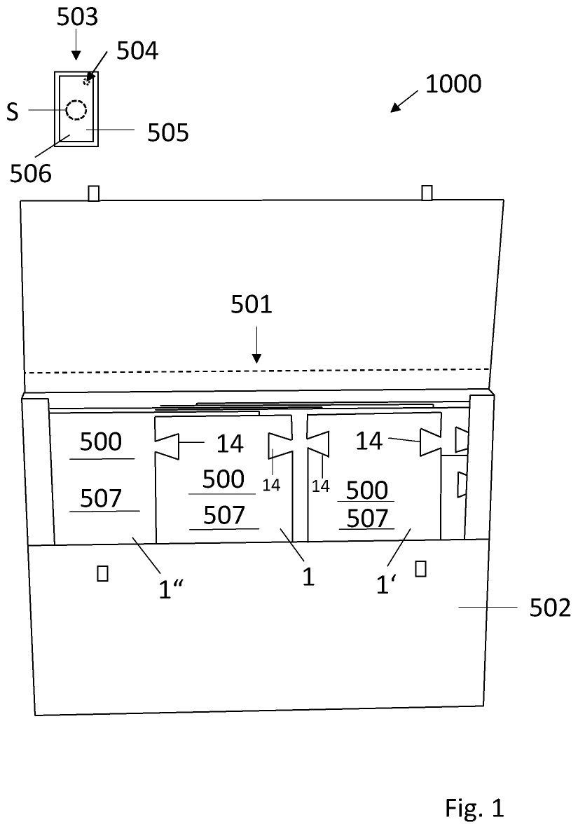

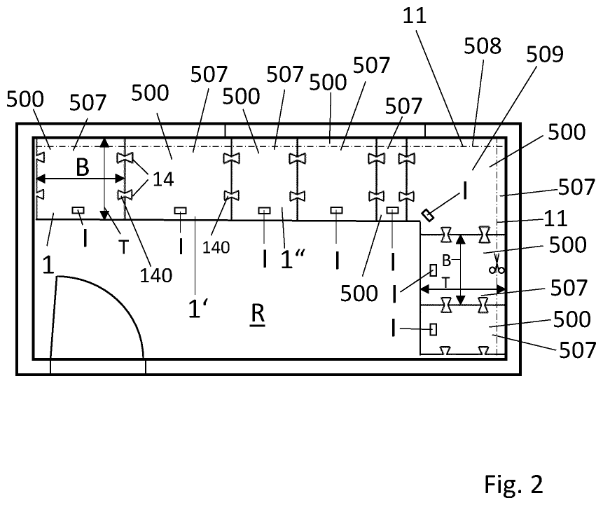

As shown, among other things, in FIGS. 1 and 2, the furnishing planning system 1000 according to the disclosure comprises multiple simulation devices 500 for simulating the floor space of multiple pieces of furniture in real size in a real room R to be furnished.

Each of the simulation fixtures 500 is formed by a physical placeholder 507 of the floor plan of a piece of furniture. The width B of each of the simulation devices 500, corresponds to a standard width of a piece of furniture, except for the corner piece 509, and the depth T of each of the simulation devices corresponds to a standard depth of a piece of furniture. The height of the simulation devices is many times smaller than the standard height of a piece of furniture. The simulation devices 500 are each plate-shaped and formed of cardboard.

With the exception of the corner piece 509, the outline of the simulation devices is rectangular in each case, having a width B and a depth T. The outline of each of the simulation devices has exactly the shape and size of the floor plan of the piece of furniture respectively simulated by them.

The simulation devices 500 each include information I containing the configuration, in this case the width and the type of the simulated piece of furniture.

The information I is preferably scannable and/or electronically readable. The simulation device 500 can comprise the information I in a machine-readable form, thus in particular in a form optimized for electronic scanning, e.g., in the form of an information code. In the exemplary embodiment shown, the simulation devices 500 each comprise the information I in machine-readable form, namely in the form of at least one barcode.

Each simulation device 500 shown includes resizing aids 508, namely multiple markings, more specifically multiple depth markings, each defining a cutting edge. In FIG. 2, only one of the multiple depth markings 11 is shown.

In all exemplary embodiments shown, the simulation devices 500 are each formed by a stencil 1, 1′, 1″.

The system 1000 comprises multiple simulation devices 500 differing in width B from each other, and connecting means 14 for connecting multiple simulation devices 500 to each other. The connecting means 14 comprise recesses of the simulation devices 500 as well as connecting pieces complementary thereto configured as connecting tabs 140. As shown for example in FIG. 2, multiple simulation devices 500 can be connected by means of the connecting means 14 to form a unit with a defined overall outline, in FIG. 2 to form a simulated kitchen.

Multiple simulation devices 500 form a set 501, namely a kitchen set.

The furnishing planning system 1000 comprises software S for an electronic data processing device 503, more specifically an electronic data processing device 503 in the form of a cell phone with software S. The software S is an app.

In addition to a database, the data processing device 503 comprises an electronic reading device 504, namely a camera, by means of which the information I can be read in, and an electronic input device 505, namely a touch screen 506.

The software is adapted to process input and/or read-in data or information containing the customer's selection or configuration, namely, to compare it with the database so that the availability, the expected delivery time and the price of his selection or configuration is shown to the customer.

The software is adapted to allow, after reading information on the customer's configuration made with the aid of the simulation device regarding the size and type of the furniture pieces, an input of the customer's selection regarding the decor of the furniture piece.

The processing of the software comprises triggering, at a furniture piece manufacturer, after a corresponding input of the customer, an order process of the furniture pieces corresponding to the selection and configuration of the customer made by means of the simulation devices.

As FIG. 1 also shows, the system 1000 comprises a container 502 for accommodating and shipping the set 501. In the exemplary embodiment shown, the container is also made of cardboard and comprises the height indicating device of the furniture planning system 1000 not shown in the figures, namely markings of different heights.

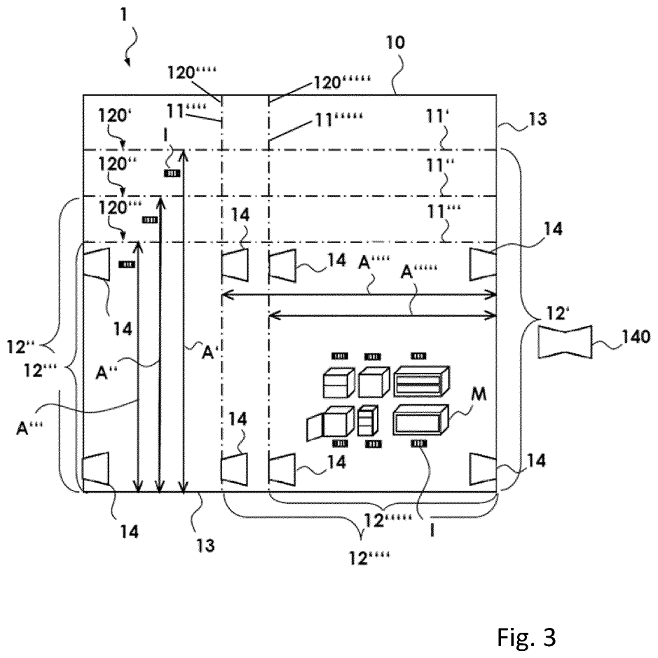

As can be seen in FIG. 3, the stencil 1 according to the disclosure is made of a material 10 in defined dimensions, wherein the stencil 1 comprises multiple markings 11′, 11″, 11′″, 11″″, 11′″″ aligned in the longitudinal and/or transverse direction of the material 10. In a particularly advantageous embodiment of the disclosure, the defined distances correspond to the standard widths A″″, A′″″, standard depths A′, A″, A′″ and/or standard heights of kitchen furniture; currently, these are widths with dimensions of approx. 10 cm, 15 cm, 20 cm, 25 cm, 30 cm, 40 cm, 45 cm, 50 cm, 60 cm, 80 cm, 90 cm, 100 cm, 120 cm, depths of approx. 35 cm, 46 cm, 55 cm and 58 cm. With the aid of the markings, the width and depth of the stencils can be changed, for example, by cutting or tearing off. The stencil can be shortened to the desired standard width and/or standard depth.

In the embodiment of the disclosure illustrated in FIG. 3, three sections 12′, 12″, 12′″ of different depth are marked by means of the markings 11′, 11″, 11′″ at a defined distance A′, A″, A′″ of their outer edges 120′, 120″, 120′″ to be created from a side edge 13 of the material, wherein at least one piece of information I which can be scanned and/or read in electronically is associated with each section 12′, 12″, 12′″ of the stencil 1. In addition, two sections 12″″, 12′″″ of different widths are marked here by means of the markings 11″″, 11′″″ at a defined distance A″″, A′″″ of their outer edges 120″″, 120′ ‘ ’″ to be created from a side edge 13 of the material.

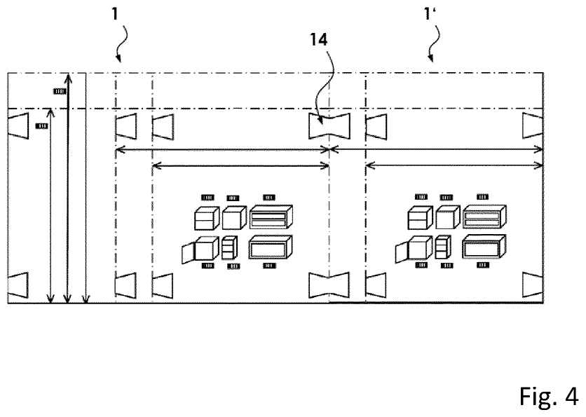

The information can include, for example, the width B of the stencil and the type of furniture M simulated by the stencil. Furthermore, connecting means 14 are provided on the side edges 13 of the material 10, by means of which the material 10 can be reversibly connected to the material 10 of at least one further stencil 1′, see FIG. 4.

The connecting means 14 is advantageously designed as a punched receptacle for inserting a connecting tab 140 or as a connecting tab 140, wherein the receptacle of a material 10 can be reversibly connected to the connecting tab 140 or to the connecting tab 140 of another material 10 by inserting the connecting tab 140 into the receptacle in a precisely fitting manner. The connecting tab 140 is preferably designed to be inserted on its opposite sides into a receptacle of multiple materials 10.

As can be seen in FIG. 3, it is particularly advantageous if at least one connecting means 14 is associated with each section 12′, 12″, 12′″, by means of which connecting means the section 12′ of the stencil 1 created by the user can be connected to a section 12′, 12″, 12′″ of a further stencil 1′.

Unlike in the exemplary embodiment shown in FIGS. 1 and 2, the stencils 1, 1′ in the exemplary embodiment shown in FIGS. 3 and 4 comprise not only depth markings 11′, 11″, 11′″ but also width markings 11″″, 11′″″.

In a further embodiment of the disclosure not shown, the connecting means 14 can also be a magnetic connecting means as part of a magnetic connection, wherein the connecting means 14 can be a magnet or a magnetically attractable material appropriately corresponding to a connecting means 14 formed as a magnet.

In a further embodiment of the disclosure, the receptacle can also be designed to appropriately correspond for insertion of the connecting tab 140 in a further material 10.

1. A furnishing planning system,
for assisting with the selection of the number, arrangement and/or configuration of pieces of furniture and/or their ordering,
wherein
the furnishing planning system has at least one simulation device configured for simulating the floor space requirement of at least one piece of furniture in a real room to be furnished.

2. The furnishing planning system according to claim 1, wherein
the simulation device comprises or is formed by at least one physical placeholder of a floor plan of a piece of furniture.

3. The furnishing planning system according to claim 1, wherein
the simulation device is plate-shaped and has an outline that at least substantially coincides with a floor plan of a piece of furniture.

4. The furnishing planning system according to claim 1, wherein
the simulation device comprises at least one piece of information which contains the configuration of the respectively simulated piece of furniture.

5. The furnishing planning system according to claim 1, wherein
the simulation device comprises resizing aids.

6. The furnishing planning system according to claim 1, wherein
the at least one simulation device comprises a stencil.

7. The furnishing planning system according to claim 1, wherein
the furnishing planning system comprises multiple simulation devices which are different from each other, include connecting means for reversibly connecting to each other and form a set.

8. The furnishing planning system according to claim 4, wherein
the furnishing planning system comprises software for an electronic data processing device.

9. The furnishing planning system according to claim 8, wherein
the data processing device comprises an electronic reading device, and the information, the reading device and the software are coordinated with one another such that the information is configured to be read by the reading device and processed in the data processing device.

10. The furnishing planning system according to claim 7, wherein
the furnishing planning system comprises a container for accommodating the simulation devices, and the mass of the container together with the simulation devices is less than 25 or 10 or 5 kg.

11. A container for a the furnishing planning system according to claim 1, wherein
multiple simulation devices for simulating the floor space requirements of a piece of furniture in a real room to be furnished are arranged in the container, which are different from each other and form a set.

12. A stencil for furniture construction or for the furnishing planning system according to claim 1, which is made of a material in defined dimensions, wherein the stencil comprises multiple markings aligned in the longitudinal and/or transverse direction of the material,
wherein
by the markings, sections of different depth, width and/or height are marked at a defined distance from their outer edges to be created to a side edge of the material, wherein at least one piece of information configured to be scanned and/or read in electronically is associated with the stencil.

13. The stencil according to claim 12,
wherein
the defined distances correspond to the standard widths, depths, and/or heights of kitchen furniture.

14. A method for using the furniture planning system according to claim 1, further including
the following steps:
configuring at least one piece of furniture by selecting and/or resizing a simulation device,
simulating the configuration in a real room to be furnished by means of the at least one simulation device,
checking the configuration, and
depending on the result of this check, either keeping the configuration, or
discarding the configuration and creating a new configuration and re-simulating and checking the new configuration.

15. The method for using a furnishing planning system according to claim 14,
wherein after keeping the configuration, the information of the at least one selected and/or resized simulation device is entered and/or read into the electronic data processing device.
